(19) United States
(12) Patent Application Publication
(10) Pub. No.: US 2011/0298657 A1
(43) Pub. Date: Dec. 8, 2011

(54) TRANSMITTING APPARATUS AND RECEIVING APPARATUS FOR TRACKING POSITION USING GPS AND THE METHOD THEREOF

(75) Inventors: Heyung Sub LEE, Daejeon (KR); Sang Hyun Mo, Daejeon (KR)

(73) Assignee: Electronics and Telecommunications Research Institute, Daejeon (KR)

(21) Appl. No.: 13/149,156

(22) Filed: May 31, 2011

(30) Foreign Application Priority Data
Jun. 1, 2010 (KR) 10-2010-0051740
Apr. 12, 2011 (KR) 10-2011-0033872

(51) Int. Cl. G01S 19/42; G01S 19/24; G01S 19/28

(52) U.S. Cl. 342/357.25; 342/357.67; 342/357.63

(57) ABSTRACT

A method of tracking a position of a transmitting apparatus in a sensor network is provided. The transmitting apparatus may receive Global Positioning System (GPS) information from each of satellites, may extract satellite time information and satellite identification information from the GPS information, may generate a transmission frame together with receiving time information and apparatus identification information, and may transmit the transmission frame to a receiving apparatus.

### CROSS-REFERENCE TO RELATED APPLICATIONS

This application claims the benefit of Korean Patent Application No. 10-2010-0051740 and of Korean Patent Application No. 10-2011-0033872, respectively filed on Jun. 1, 2010 and Apr. 12, 2011, in the Korean Intellectual Property Office, the disclosures of which are incorporated herein by reference.

### BACKGROUND

1. Field of the Invention

The present invention relates to a technology for tracking a position of a transmitting apparatus using an apparatus enabling transmission and reception of signals, for example a Radio Frequency Identification (RFID) tag and the like.

2. Description of the Related Art

A Radio Frequency Identification (RFID) technology was developed for military purpose in World War II, and is recently being applied in various fields. In particular, the RFID technology is used to track a position of an object, such as a human and an animal, or an inanimate object. A position tracking technology may be performed to track a position of an object with an attached RFID tag, by detecting the object using at least three readers. The RFID tag may typically be used to track the position of the object with the attached RFID tag, using a triangulation scheme and signals detected by the at least three readers.

However, in a conventional position tracking technology, at least three readers need to detect an RFID tag. Accordingly, when an RFID tag moves out of a predetermined region in which the at least three readers are included, it is difficult to track a position of an object to which the RFID tag is attached.

Additionally, when the RFID tag computes position coordinates of the object with the attached RFID tag, power consumption may increase, and the life of the RFID tag may be reduced.

Accordingly, there is a desire for a technology that may track a position of an object even when an RFID tag moves out of a predetermined region in which a reader is included, and may reduce power consumption.

### SUMMARY

An aspect of the present invention provides a technology that may track a position of an object, even when a Radio Frequency Identification (RFID) tag moves out of a predetermined region in which a reader is included.

Another aspect of the present invention provides a technology that may extend a life of an RFID tag employing a battery, while reducing power consumption of the RFID tag.

According to an aspect of the present invention, there is provided a transmitting apparatus, including: a Global Positioning System (GPS) information processor to generate receiving time information based on a time at which GPS information is received; and a transmission frame generator to generate a transmission frame based on the receiving time information and the GPS information.

The GPS information processor may extract satellite time information and satellite identification information from the GPS information. Here, the transmission frame generator may generate a transmission frame including the satellite time information, the satellite identification information, the receiving time information, and apparatus identification information.

The GPS information processor may receive the GPS information from each of a plurality of satellites in an active mode.

The transmission frame generator may discard the GPS information, when the transmission frame is generated.

The transmitting apparatus may further include a sensing information generator to generate sensing information using at least one sensor.

According to another aspect of the present invention, there is provided a position tracking method, including: generating receiving time information based on a time at which GPS information is received; and generating a transmission frame based on the receiving time information and the GPS information.

The position tracking method may further include extracting satellite time information and satellite identification information from the GPS information. Here, the generating of the transmission frame may include generating a transmission frame including at least one of the receiving time information, the satellite time information, the satellite identification information, and apparatus identification information.

The position tracking method may further include generating time difference information for each satellite, based on the receiving time information and the satellite time information.

The position tracking method may further include receiving the GPS information from each of a plurality of satellites in an active mode.

The position tracking method may further include modulating the transmission frame, and transmitting the modulated transmission frame to a receiving apparatus.

The position tracking method may further include generating sensing information using at least one sensor.

According to another aspect of the present invention, there is provided a receiving apparatus, including: a frame receiver to demodulate a transmission frame received from a transmitting apparatus; and a position information generator to generate position information of the transmitting apparatus based on the transmission frame and GPS information.

The position information generator may extract, from the transmission frame, at least one of receiving time information, time difference information, apparatus identification information, satellite time information, and satellite identification information.

The position information generator may generate the position information of the transmitting apparatus based on the GPS information and the time difference information.

The position information generator may generate time difference information for each satellite, based on the receiving time information and the satellite time information.

The receiving apparatus may further include an interface unit to transmit, to a central server, at least one of the position information of the transmitting apparatus, the apparatus identification information, and sensing information.

According to another aspect of the present invention, there is provided a position tracking method, including: demodulating a transmission frame received from a transmitting apparatus; and generating position information of the transmitting apparatus based on the transmission frame and GPS information.

The generating of the position information may include extracting, from the transmission frame, at least one of receiving time information, time difference information, apparatus identification information, satellite time information, and satellite identification information, and generating the position information of the transmitting apparatus using the GPS information and the time difference information.

The position tracking method may further include transmitting, to a central server, the position information of the transmitting apparatus and the apparatus identification information.

The position tracking method may further include transmitting, to the central server, at least one of the position information of the transmitting apparatus, the apparatus identification information, and sensing information.

The position tracking method may further include decrypting the demodulated transmission frame.

### Effect

According to embodiments of the present invention, it is possible to track a position of an object with an attached Radio Frequency Identification (RFID) tag, using Global Positioning System (GPS) information, even when the RFID tag moves out of a predetermined region in which a reader is included.

Additionally, according to embodiments of the present invention, when an RFID reader performs an operation for tracking a position of an object, it is possible to reduce power consumption of an RFID tag, as well as to extend a life of the RFID tag.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating an overall system configured with satellites, transmitting apparatuses, and receiving apparatuses according to an embodiment of the present invention;

FIGS. 2 and 5 are block diagrams illustrating examples of transmitting apparatuses according to an embodiment of the present invention;

FIGS. 3 and 6 are block diagrams illustrating examples of receiving apparatuses according to an embodiment of the present invention;

FIGS. 4 and 7 are flowcharts illustrating examples of an operation of tracking a position of a transmitting apparatus according to an embodiment of the present invention; and

FIG. 8 is a diagram illustrating a military system to which a transmitting apparatus and receiving apparatuses are applied according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

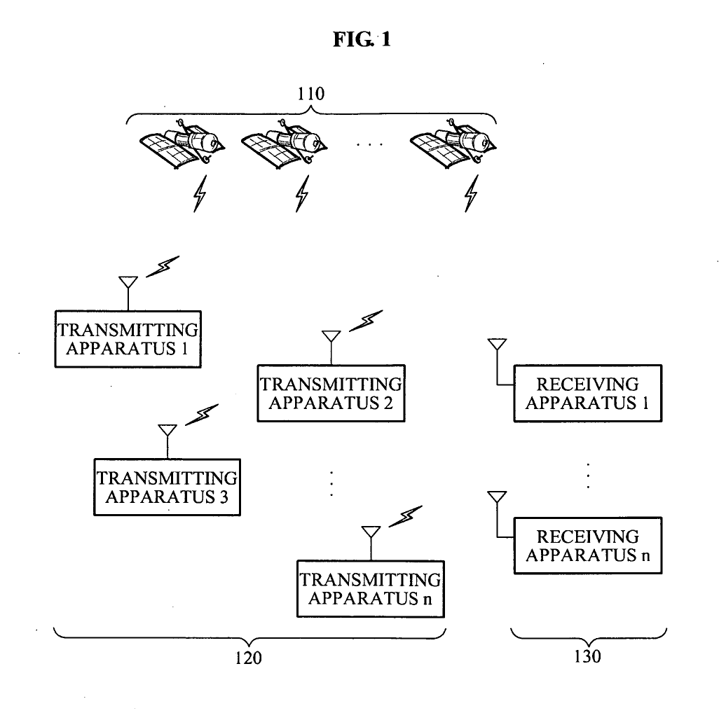

FIG. 1 is a diagram illustrating an overall system configured with satellites, transmitting apparatuses, and receiving apparatuses according to an embodiment of the present invention.

Referring to FIG. 1, a plurality of transmitting apparatuses 120 and a plurality of receiving apparatuses 130 may respectively receive Global Positioning System (GPS) information from a plurality of satellites 110. While the plurality of transmitting apparatuses 120 and the plurality of receiving apparatuses 130 are illustrated in FIG. 1, this is merely an example. Accordingly, at least one transmitting apparatus and at least one receiving apparatus may be included in the system.

The plurality of satellites 110 may simultaneously transmit the GPS information to a transmitting apparatus and a receiving apparatus. Here, the transmitting apparatus may be, for example, one of the transmitting apparatuses 120, and the receiving apparatus may be, for example, one of the receiving apparatuses 130. Additionally, the plurality of satellites 110 may be synchronized in time with each other. Accordingly, the plurality of satellites 110 may transmit the GPS information to the transmitting apparatus and the receiving apparatuses, at the same time.

The transmitting apparatus may receive GPS information from each of the plurality of satellites 110. The GPS information may include satellite time information, satellite identification information, latitude information, longitude information, and the like. The receiving apparatus may also receive the GPS information from each of the plurality of satellites 110. In other words, the GPS information received by the receiving apparatus may be identical to the GPS information received by the transmitting apparatus.

When the GPS information is received, the transmitting apparatus may extract, for each of the plurality of satellites 110 from the received GPS information, the satellite time information and the satellite identification information. Here, the satellite identification information may include satellite identifications (IDs) to identify the plurality of satellites 110.

For example, the transmitting apparatus may receive first GPS information through fourth GPS information from a first satellite through a fourth satellite, respectively. Subsequently, the transmitting apparatus may extract, from the first GPS information, first satellite time information and first satellite identification information, and may extract, from the second GPS information, second satellite time information and second satellite identification information. Similarly, the transmitting apparatus may extract, from the third GPS information, third satellite time information and third satellite identification information, and may extract, from the fourth GPS information, fourth satellite time information and fourth satellite identification information.

Additionally, the transmitting apparatus may generate receiving time information for each of the satellites 110. The receiving time information may include information on a time at which the GPS information is received from each of the satellites 110.

Furthermore, the transmitting apparatus may generate time difference information for each of the satellites 110, based on the receiving time information and the satellite time information. For example, when first GPS information through fourth GPS information are respectively received from a first satellite through a fourth satellite, the transmitting apparatus may generate first time difference information as a difference between first satellite time information and first receiving time information associated with reception of the first GPS information, and may generate second time difference information as a difference between second satellite time information and second receiving time information. Similarly, the transmitting apparatus may generate third time difference information as a difference between third satellite time information and third receiving time information, and may generate fourth time difference information as a difference between fourth satellite time information and fourth receiving time information.

Subsequently, the transmitting apparatus may generate a transmission frame including apparatus identification information, the receiving time information, the satellite time information, and the satellite identification information. Here, the apparatus identification information may include, for example, information on an ID of the transmitting apparatus. For example, when time difference information is generated, the transmitting apparatus may generate a transmission frame including the generated time difference information in addition to the receiving time information, the apparatus identification information, the satellite time information, and the satellite identification information.

Here, the receiving time information may include information regarding a time at which the transmitting apparatus receives the GPS information from each of the satellites, and the satellite time information may include information regarding a time at which each of the satellites transmits the GPS information to the transmitting apparatus. Additionally, the time difference information may include information regarding a difference between the satellite time information and the receiving time information, and may refer to a transit time between each of the satellites and the transmitting apparatus.

Moreover, the transmitting apparatus may modulate the transmission frame, and may transmit, to the receiving apparatus, the modulated transmission frame carried in a carrier frequency.

To modulate the transmission frame, the transmitting apparatus may use a modulation scheme, for example, a Direct Sequence Spread Spectrum (DSSS) modulation scheme or a Chirp Spread Spectrum (CSS) modulation scheme. Here, the transmitting apparatus may carry, in the carrier frequency, the modulated transmission frame together with error checking information such as a Cyclic Redundancy Check (CRC) and the like, and may transmit, to the receiving apparatus, the modulated transmission frame along with the error checking information.

Subsequently, the receiving apparatus may demodulate the transmission frame received from the transmitting apparatus, and may generate position information of the transmitting apparatus, based on the demodulated transmission frame and the GPS information received from satellites. Here, the transmission frame may include at least one of the receiving time information, the apparatus identification information, the satellite time information, and the satellite identification information.

The receiving apparatus may transmit, to a central server, the position information of the transmitting apparatus, and the apparatus identification information. Here, the central server may include, for example, a control center and the like. When the position information and the apparatus identification information are received, the central server may determine a position of the transmitting apparatus, based on the received position information and the received apparatus identification information. For example, the central server may determine a position of an object to which the transmitting apparatus is attached. Accordingly, the central server may transmit, to the transmitting apparatus, an instruction to control an operation of the object.

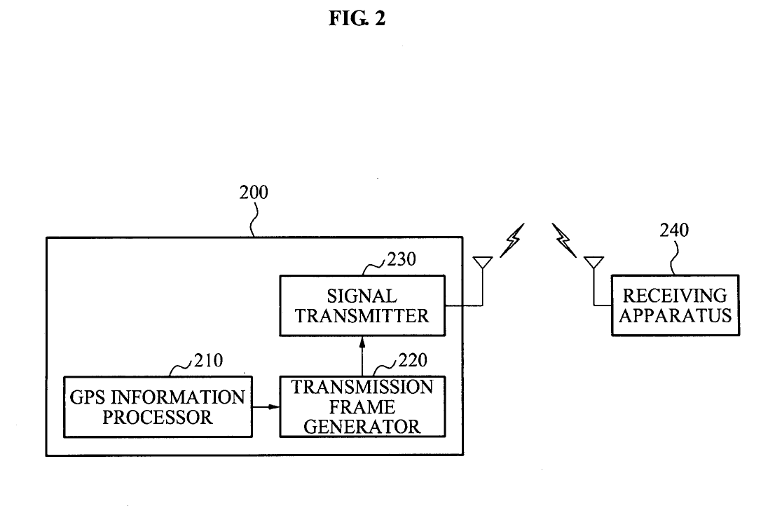

FIG. 2 is a block diagram illustrating a configuration of a transmitting apparatus 200 according to an embodiment of the present invention.

Referring to FIG. 2, the transmitting apparatus 200 may include a GPS information processor 210, a transmission frame generator 220, and a signal transmitter 230.

The GPS information processor 210 may receive GPS information from each of a plurality of satellites. Here, the GPS information may include satellite time information, satellite identification information, latitude information, longitude information, and the like. For example, the GPS information processor 210 may receive the GPS information periodically or randomly.

Additionally, when the transmitting apparatus 200 is powered on, the GPS information processor 210 may be switched from a sleep mode to an active mode. In the active mode, the GPS information processor 210 may receive the GPS information from each of the plurality of satellites. In the sleep mode, the GPS information processor 210 may not receive the GPS information from the plurality of satellites and accordingly, power consumption may be reduced.

The GPS information processor 210 may generate receiving time information for each of the satellites, based on a time at which the GPS information is received from each of the satellites. Subsequently, the GPS information processor 210 may extract, from the GPS information, the satellite time information, and the satellite identification information. Additionally, the GPS information processor 210 may transfer, to the transmission frame generator 220, the satellite time information, the satellite identification information, and the receiving time information.

The transmission frame generator 220 may generate a transmission frame including the satellite time information of each of the satellites, the satellite identification information of each of the satellites, the receiving time information of each of the satellites, and apparatus identification information.

For example, when four pieces of GPS information are respectively received from four satellites, the transmission frame generator 220 may generate a transmission frame including four pieces of satellite time information, four pieces of satellite identification information, four pieces of receiving time information, and apparatus identification information. In this example, the apparatus identification information may include an ID of the transmitting apparatus 200.

When the transmission frame is generated, the transmission frame generator 220 may discard the GPS information of each of the satellites. Accordingly, the transmitting apparatus 200 may generate a transmission frame even using a small capacity of a memory, and thus it is possible to reduce a unit cost and size of the transmitting apparatus 200.

Additionally, the transmission frame generator 220 may modulate the transmission frame. For example, the transmission frame generator 220 may use a CSS modulation scheme or a DSSS modulation scheme, to modulate the transmission frame.

When the transmission frame is modulated, the signal transmitter 230 may carry the modulated transmission frame in a carrier frequency, and may transmit the modulated transmission frame to a receiving apparatus 240 via an antenna. Here, the signal transmitter 230 may transmit, to the receiving apparatus 240 via the antenna, error checking information together with the modulated transmission frame.

The GPS information processor 210 may generate time difference information, based on the satellite time information extracted from the GPS information, and based on the receiving time information. For example, the GPS information processor 210 may generate four pieces of time difference information based on four pieces of satellite time information and four pieces of receiving time information of four satellites, respectively. Subsequently, the transmission frame generator 220 may generate a transmission frame including at least one of the satellite time information, the satellite identification information, the time difference information, the receiving time information, and the apparatus identification information. Additionally, the transmission frame generator 220 may modulate the transmission frame. The signal transmitter 230 may transmit the modulated transmission frame via the antenna to the receiving apparatus 240.

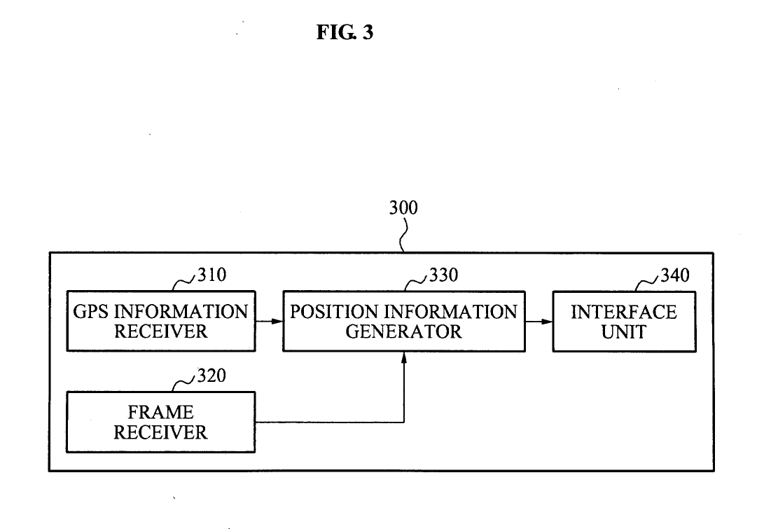

FIG. 3 is a block diagram illustrating a configuration of a receiving apparatus 300 according to an embodiment of the present invention.

Referring to FIG. 3, the receiving apparatus 300 may include a GPS information receiver 310, a frame receiver 320, a position information generator 330, and an interface unit 340.

The GPS information receiver 310 may receive GPS information from each of a plurality of satellites. Here, the GPS information may include satellite time information, satellite identification information, latitude information, longitude information, and the like. The GPS information received by the GPS information receiver 310 may be identical to the GPS information received by the transmitting apparatus 200 of FIG. 2.

For example, the plurality of satellites may be synchronized in time with each other, based on synchronization information. When the synchronization is completed, the plurality of satellites may respectively transmit the GPS information at the same time. Accordingly, the transmitting apparatus 200 and the receiving apparatus 300 may receive the GPS information from each of the plurality of satellites.

The frame receiver 320 may receive a transmission frame transmitted from at least one transmitting apparatus. Here, the frame receiver 320 may also receive error checking information together with the transmission frame. The transmission frame may include at least one of receiving time information, time difference information, apparatus identification information, satellite time information, and satellite identification information.

Additionally, the frame receiver 320 may demodulate the transmission frame, and may extract, from the transmission frame, at least one of the receiving time information, the time difference information, the apparatus identification information, the satellite time information, and the satellite identification information. Here, the receiving time information may include information regarding a time at which the transmitting apparatus receives the GPS information from each of the satellites, and the satellite time information may include information regarding a time at which each of the satellites transmits the GPS information to the transmitting apparatus. Additionally, the time difference information may include information regarding a difference between the satellite time information and the receiving time information, and may refer to a transit time between each of the satellites and the transmitting apparatus.

In an example in which time difference information is generated by the transmitting apparatus, the frame receiver 320 may extract, from the transmission frame, the receiving time information, the time difference information, the apparatus identification information, the satellite time information, and the satellite identification information.

In another example in which the time difference information is not generated by the transmitting apparatus, the frame receiver 320 may extract, from the transmission frame, the receiving time information, the apparatus identification information, the satellite time information, and the satellite identification information.

The position information generator 330 may generate position information of the transmitting apparatus, using the GPS information of each of the satellites and the receiving time information of each of the satellites. Here, the position information of the transmitting apparatus may include, for example, geographic position coordinates of the transmitting apparatus.

In an example in which time difference information is extracted from the transmission frame, the position information generator 330 may generate position information of the transmitting apparatus, using the time difference information of each of the satellites and the GPS information of each of the satellites.

In another example in which the time difference information is not extracted from the transmission frame, the position information generator 330 may generate time difference information for each of the satellites, based on a difference between the receiving time information and the satellite time information. Additionally, the position information generator 330 may generate position information of the transmitting apparatus, using the generated time difference information, and the GPS information received from the satellites.

The interface unit 340 may transmit, to a central server, the position information of the transmitting apparatus, and the apparatus identification information. Here, the central server may include, for example, a control center. When the position information and the apparatus identification information are received, the central server may control an operation of the transmitting apparatus, based on the received position information and the received apparatus identification information.

As described above with reference to FIGS. 2 and 3, the receiving apparatus 300, instead of the transmitting apparatus 200, may generate position information of the transmitting apparatus 200 and accordingly, the transmitting apparatus 200 may not need to include a processor, such as a Digital Signal Processor (DSP) required to generate position information and the like. In other words, a position of the transmitting apparatus 200 may be tracked by the receiving apparatus 300, instead of the transmitting apparatus 200. Accordingly, it is possible to lower a unit cost and power of the transmitting apparatus 200, and to reduce a size of the transmitting apparatus 200.

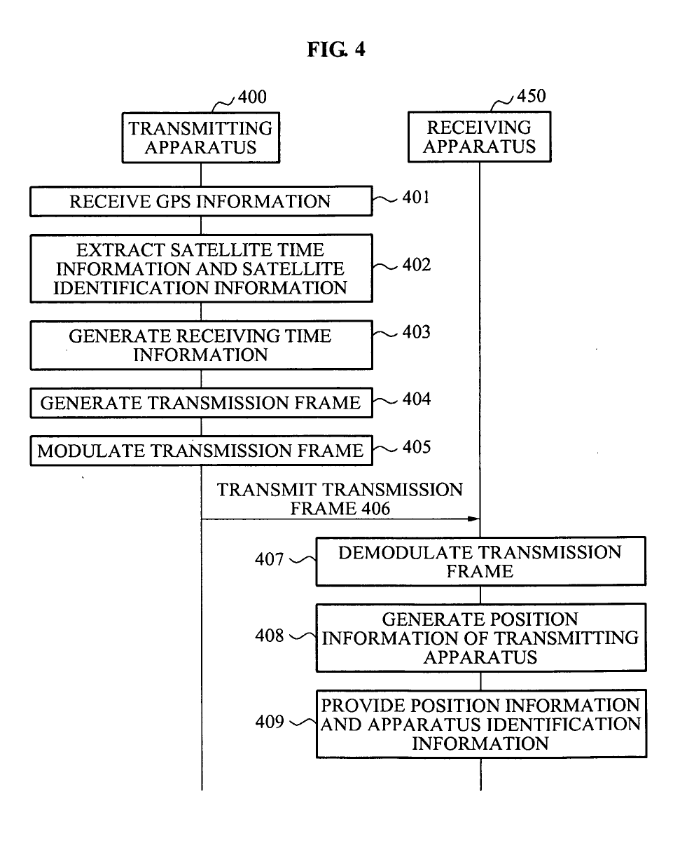

FIG. 4 is a flowchart illustrating an operation of tracking a position of a transmitting apparatus 400 according to an embodiment of the present invention.

In FIG. 4, in operation 401, the transmitting apparatus 400 may receive GPS information from each of a plurality of satellites. Here, the GPS information may include satellite time information, satellite identification information, latitude information, longitude information, and the like. Also, a receiving apparatus 450 may receive the GPS information from each of the plurality of satellites.

In operation 402, the transmitting apparatus 400 may extract, from the GPS information, the satellite time information and the satellite identification information. Specifically, the transmitting apparatus 400 may extract the satellite time information and the satellite identification information, for each of the plurality of satellites. For example, when four pieces of GPS information are respectively received from four satellites, the transmitting apparatus 400 may extract, from each of the four pieces of GPS information, satellite time information and satellite identification information.

In operation 403, the transmitting apparatus 400 may generate receiving time information for each of the plurality of satellites, based on a time at which the GPS information is received from each of the plurality of satellites. Here, the transmitting apparatus 400 may generate time difference information for each of the plurality of satellites, based on the receiving time information and the satellite time information.

In operation 404, the transmitting apparatus 400 may generate a transmission frame. The transmission frame may include at least one of apparatus identification information, the satellite time information, the satellite identification information, the receiving time information, and the time difference information.

In an example in which the time difference information is generated, the transmitting apparatus 400 may generate a transmission frame including the satellite time information, the satellite identification information, the apparatus identification information, the receiving time information, and the time difference information.

In another example in which the time difference information is not generated, the transmitting apparatus 400 may generate a transmission frame including the satellite time information, the satellite identification information, the apparatus identification information, and the receiving time information.

In operation 405, the transmitting apparatus 400 may modulate the transmission frame. To modulate the transmission frame, the transmitting apparatus 400 may use, for example, a DSSS modulation scheme, a CSS modulation scheme, and the like.

In operation 406, the transmitting apparatus 400 may transmit, to the receiving apparatus 450, the modulated transmission frame carried in a carrier frequency. Specifically, the transmitting apparatus 400 may carry, in the carrier frequency, the modulated transmission frame together with error checking information, and may transmit the modulated transmission frame together with the error checking information.

In operation 407, the receiving apparatus 450 may receive the transmission frame from the transmitting apparatus 400, and may demodulate the received transmission frame. Here, the receiving apparatus 450 may receive a transmission frame transmitted from at least one transmitting apparatus.

In operation 408, the receiving apparatus 450 may generate position information of the transmitting apparatus 400, based on the transmission frame and GPS information. Specifically, the receiving apparatus 450 may extract, from the transmission frame, at least one of the satellite time information, the satellite identification information, the apparatus identification information, the receiving time information, and the time difference information.

In an example in which the time difference information is included in the transmission frame, the receiving apparatus 450 may extract, from the transmission frame, the satellite time information, the satellite identification information, the apparatus identification information, the receiving time information, and the time difference information. Subsequently, the receiving apparatus 450 may generate the position information of the transmitting apparatus 400, using the time difference information of each of the satellites and the GPS information of each of the satellites.

In another example in which the time difference information is not included in the transmission frame, the receiving apparatus 450 may generate time difference information for each of the plurality of satellites, based on the satellite time information and the receiving time information. Additionally, the receiving apparatus 450 may generate the position information of the transmitting apparatus 400, using the generated time difference information and the GPS information of each of the satellites.

In operation 409, the receiving apparatus 450 may provide a central server with the generated position information and the apparatus identification information. When the position information and the apparatus identification information are received, the central server may determine a position of an object to which the transmitting apparatus 400 is attached, based on the received position information and the received apparatus identification information. Accordingly, the central server may control an operation of the transmitting apparatus 400, based on the determined position of the object.

In FIG. 4, the transmitting apparatus 400 may generate the receiving time information, before extracting the satellite time information and the satellite identification information.

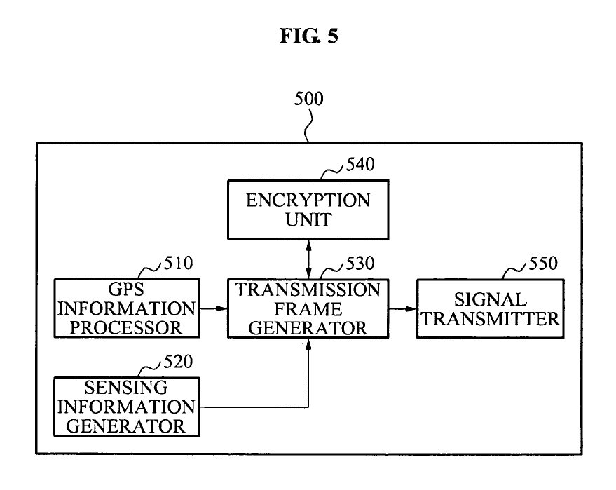

FIG. 5 is a block diagram illustrating a configuration of a transmitting apparatus 500 according to an embodiment of the present invention.

Referring to FIG. 5, the transmitting apparatus 500 may include a GPS information processor 510, a sensing information generator 520, a transmission frame generator 530, an encryption unit 540, and a signal transmitter 550. The transmitting apparatus 500 of FIG. 5 may be configured by adding, to the transmitting apparatus 200 of FIG. 2, the sensing information generator 520 and the encryption unit 540. Accordingly, further descriptions of the GPS information processor 510, the transmission frame generator 530, and the signal transmitter 550 of FIG. 5 will be omitted.

The GPS information processor 510 may receive GPS information from each of a plurality of satellites. Here, the GPS information may include satellite time information, satellite identification information, latitude information, longitude information, and the like. For example, in the active mode, the GPS information processor 510 may receive the GPS information from each of the plurality of satellites. In the sleep mode, the GPS information processor 510 may not receive the GPS information from the plurality of satellites and accordingly, it is possible to reduce power consumption.

Additionally, the GPS information processor 510 may generate receiving time information for each of the plurality of satellites, based on a time at which the GPS information is received. Subsequently, the GPS information processor 510 may extract, from the GPS information, the satellite time information and the satellite identification information. Furthermore, the GPS information processor 510 may transfer, to the transmission frame generator 530, the satellite time information, the satellite identification information, and the receiving time information.

Here, the GPS information processor 510 may generate time difference information for each of the plurality of satellites, using the receiving time information and the satellite time information. When the time difference information is generated, the GPS information processor 510 may transfer, to the transmission frame generator 530, the time difference information, the receiving time information, the satellite time information, and the satellite identification information.

The sensing information generator 520 may generate sensing information based on a signal detected by at least one sensor. Here, the at least one sensor may be attached to the transmitting apparatus 500, or to an object to which the transmitting apparatus 500 is attached. For example, the sensing information generator 520 generate sensing information based on signals detected by a temperature sensor, an infrared sensor, an angular velocity sensor, an acceleration sensor, a gyro sensor, and the like. Accordingly, the sensing information may be used to predict a state of an environment around the transmitting apparatus 500.

The transmission frame generator 530 may generate a transmission frame including at least one of apparatus identification information, the sensing information, the satellite time information, the satellite identification information, the time difference information, and the receiving time information.

In an example in which the time difference information is generated, the transmission frame generator 530 may generate a transmission frame including the sensing information, the satellite time information, the satellite identification information, the apparatus identification information, the time difference information, and the receiving time information.

In another example in which the time difference information is not generated, the transmission frame generator 530 may generate a transmission frame including the sensing information, the satellite time information, the satellite identification information, the apparatus identification information, and the receiving time information.

The transmission frame generator 530 may discard the GPS information of each of the satellites, when the transmission frame is generated.

The encryption unit 540 may encrypt the transmission frame. When the transmission frame is encrypted, the transmission frame generator 530 may modulate the encrypted transmission frame, using a DSSS modulation scheme or a CSS modulation scheme. The signal transmitter 550 may transmit the modulated transmission frame to a receiving apparatus via an antenna.

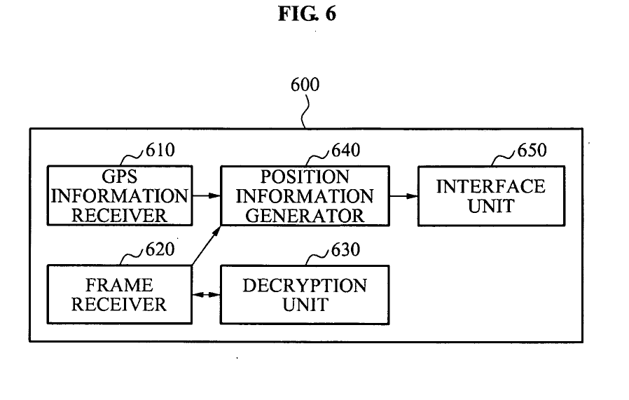

FIG. 6 is a block diagram illustrating a configuration of a receiving apparatus 600 according to an embodiment of the present invention.

Referring to FIG. 6, the receiving apparatus 600 may include a GPS information receiver 610, a frame receiver 620, a decryption unit 630, a position information generator 640, and an interface unit 650. The receiving apparatus 600 of FIG. 6 may be configured by adding the decryption unit 630 to the receiving apparatus 300 of FIG. 3, and accordingly further descriptions of the GPS information receiver 610, the frame receiver 620, the position information generator 640, and the interface unit 650 will be omitted.

The GPS information receiver 610 may receive GPS information from each of a plurality of satellites. Here, the GPS information may include satellite time information, satellite identification information, latitude information, longitude information, and the like.

The frame receiver 620 may receive a transmission frame transmitted from at least one transmitting apparatus. Specifically, the frame receiver 620 may receive the transmission frame encrypted by the transmitting apparatus. Here, the transmission frame may include at least one of receiving time information, time difference information, apparatus identification information, satellite time information, satellite identification information, and sensing information.

Additionally, the frame receiver 620 may demodulate the received transmission frame. When the transmission frame is demodulated, the decryption unit 630 may restore the transmission frame by decrypting the transmission frame. When the transmission frame is restored, the frame receiver 620 may extract, from the transmission frame, at least one of the receiving time information, the time difference information, the apparatus identification information, the satellite time information, the satellite identification information, and the sensing information.

In an example in which time difference information is generated by the transmitting apparatus, the frame receiver 620 may extract, from the transmission frame, the receiving time information, the time difference information, the apparatus identification information, the satellite time information, the satellite identification information, and the sensing information.

In another example in which time difference information is not generated by the transmitting apparatus, the frame receiver 620 may extract, from the transmission frame, the receiving time information, the apparatus identification information, the satellite time information, the satellite identification information, and the sensing information.

The position information generator 640 may generate position information of the transmitting apparatus, using the GPS information of each of the satellites and the receiving time information of each of the satellites. Here, the position information of the transmitting apparatus may include, for example, geographic position coordinates of the transmitting apparatus.

The interface unit 650 may transmit, to a central server, the position information of the transmitting apparatus, the apparatus identification information, and the sensing information. Here, the central server may include, for example, a control center. When the position information, the apparatus identification information, and the sensing information are received, the central server may control an operation of the transmitting apparatus, based on the received position information and the received apparatus identification information, and may predict an environment around the transmitting apparatus, based on the received sensing information.

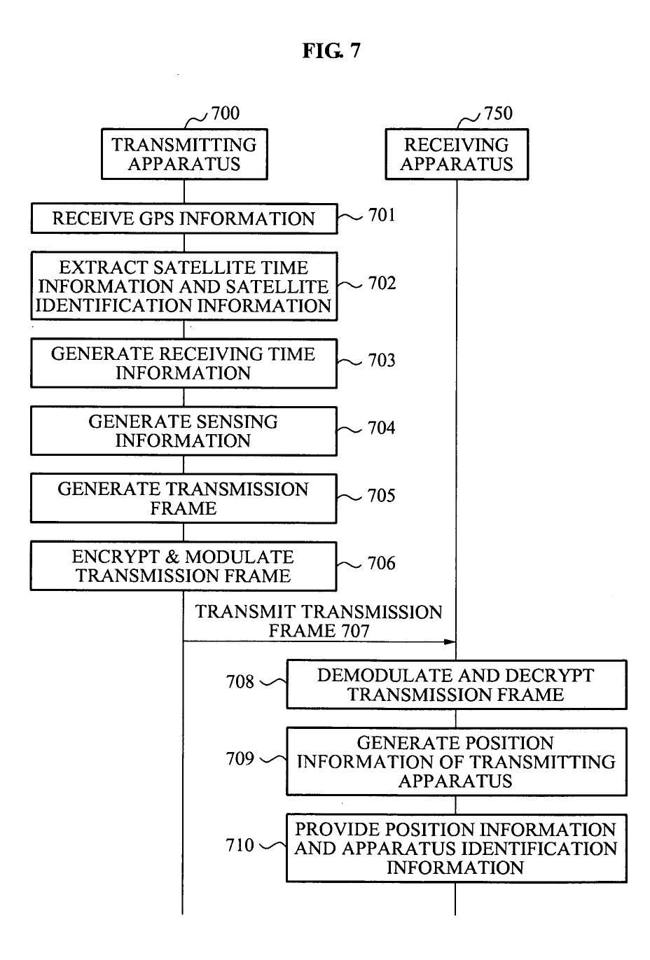

FIG. 7 is a flowchart illustrating an operation of tracking a position of a transmitting apparatus 700 according to an embodiment of the present invention.

In FIG. 7, in operation 701, the transmitting apparatus 700 may receive GPS information from each of a plurality of satellites. Here, the GPS information may include satellite time information, satellite identification information, latitude information, longitude information, and the like. Also, a receiving apparatus 750 may receive the GPS information from each of the plurality of satellites.

In operation 702, the transmitting apparatus 700 may extract, from the GPS information, the satellite time information and the satellite identification information. Specifically, the transmitting apparatus 700 may extract the satellite time information and the satellite identification information, for each of the plurality of satellites.

In operation 703, the transmitting apparatus 700 may generate receiving time information for each of the plurality of satellites, based on a time at which the GPS information is received from each of the plurality of satellites. Here, the transmitting apparatus 700 may generate time difference information for each of the plurality of satellites, based on the receiving time information and the satellite time information.

In operation 704, the transmitting apparatus 700 may generate sensing information based on a signal detected by at least one sensor.

In operation 705, the transmitting apparatus 700 may generate a transmission frame. Here, the transmission frame may include at least one of apparatus identification information, the satellite time information, the satellite identification information, the sensing information, the receiving time information, and the time difference information.

In an example in which the time difference information is generated, the transmitting apparatus 700 may generate a transmission frame including the satellite time information, the satellite identification information, the apparatus identification information, the receiving time information, the time difference information, and the sensing information.

In another example in which the time difference information is not generated, the transmitting apparatus 700 may generate a transmission frame including the satellite time information, the satellite identification information, the apparatus identification information, the receiving time information, and the sensing information.

In operation 706, the transmitting apparatus 700 may encrypt and modulate the transmission frame.

In operation 707, the transmitting apparatus 700 may transmit the modulated transmission frame to the receiving apparatus 750.

In operation 708, the receiving apparatus 750 may demodulate and decrypt the modulated transmission frame, and may restore the transmission frame.

In operation 709, the receiving apparatus 750 may generate position information of the transmitting apparatus 700, based on the transmission frame and GPS information.

In an example in which the time difference information is included in the transmission frame, the receiving apparatus 750 may extract, from the transmission frame, the satellite time information, the satellite identification information, the apparatus identification information, the sensing information, the receiving time information, and the time difference information. Subsequently, the receiving apparatus 750 may generate the position information of the transmitting apparatus 700, using the time difference information of each of the satellites and the GPS information of each of the satellites.

In another example in which the time difference information is not included in the transmission frame, the receiving apparatus 750 may generate time difference information for each of the plurality of satellites, based on the satellite time information and the receiving time information. Additionally, the receiving apparatus 750 may generate the position information of the transmitting apparatus 700, using the generated time difference information and the GPS information of each of the satellites.

In operation 710, the receiving apparatus 750 may provide a central server with the generated position information, the sensing information, and the apparatus identification information. When the position information, the sensing information, and the apparatus identification information are received, the central server may determine a position of an object to which the transmitting apparatus 700 is attached, based on the received position information and the received apparatus identification information, so that the central server may control an operation of the transmitting apparatus 700, based on the determined position of the object. Additionally, the central server may predict an environment around the transmitting apparatus 700, based on the received sensing information.

As described above, the transmitting apparatus 700 may generate the sensing information, after extracting the satellite time information and the satellite identification information from the GPS information, but there is no limitation thereto. Accordingly, the transmitting apparatus 700 may generate the sensing information, before or after receiving the GPS information from the satellites, and before or after extracting the satellite time information and the satellite identification information.

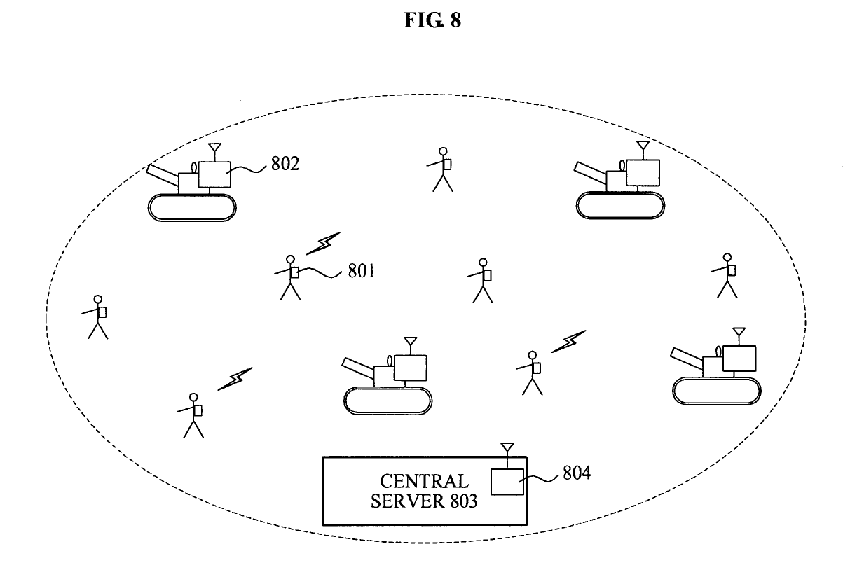

FIG. 8 is a diagram illustrating a military system to which a transmitting apparatus 801 and receiving apparatuses 802 and 804 are applied, according to an embodiment of the present invention.

Referring to FIG. 8, the transmitting apparatus 801 may be attached to each of users, for example soldiers. Additionally, the receiving apparatus 802 may be attached to a tank, a car and the like, and the receiving apparatus 804 may be attached to a central server 803.

The transmitting apparatus 801 may receive GPS information from each of satellites, may generate receiving time information, and may extract, from the GPS information, satellite time information and satellite identification information. Additionally, the transmitting apparatus 801 may transmit, to the receiving apparatuses 802 and 804, the satellite time information, the satellite identification information, the receiving time information, and apparatus identification information. Subsequently, the receiving apparatuses 802 and 804 may generate time difference information, based on the received satellite time information and the received receiving time information. Additionally, the receiving apparatuses 802 and 804 may generate position information of the transmitting apparatus 801, based on the generated time difference information and the GPS information. The receiving apparatuses 802 and 804 may transmit, to the central server 803, the generated position information, and the apparatus identification information. Accordingly, the central server 803 may determine a position of the transmitting apparatus 801, and may transmit an instruction, such as military operations and the like, to the transmitting apparatus 801, so that the instruction may be transferred to each of the users.

The transmitting apparatuses and the receiving apparatuses described above with reference to FIGS. 2 through 8 may include, for example, sensor nodes used to form a sensor network. For example, a Radio Frequency Identification (RFID) tag may be used as a transmitting apparatus, and an RFID reader may be used as a receiving apparatus. Additionally, a Bluetooth chipset or a ZigBee chipset may be used as a transmitting apparatus, and a Bluetooth module or a ZigBee module may be used as a receiving apparatus. Furthermore, a portable chipset enabling formation of an ad-hoc network may be used as a transmitting apparatus, and a module enabling pairing with the portable chipset to communicate with the portable chipset may be used as a receiving apparatus.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A transmitting apparatus, comprising:
a Global Positioning System (GPS) information processor to generate receiving time information based on a time at which GPS information is received; and
a transmission frame generator to generate a transmission frame based on the receiving time information and the GPS information.

2. The transmitting apparatus of claim 1, wherein the GPS information processor extracts satellite time information and satellite identification information from the GPS information, and
wherein the transmission frame generator generates a transmission frame comprising the satellite time information, the satellite identification information, the receiving time information, and apparatus identification information.

3. The transmitting apparatus of claim 1, wherein the GPS information processor generates time difference information for each satellite, based on satellite time information extracted from the GPS information and the receiving time information, and
wherein the transmission frame generator generates a transmission frame comprising the satellite time information, the time difference information, satellite identification information, and apparatus identification information.

4. The transmitting apparatus of claim 1, wherein the GPS information processor receives the GPS information from each of a plurality of satellites in an active mode.

5. The transmitting apparatus of claim 1, wherein the transmission frame generator discards the GPS information, when the transmission frame is generated.

6. The transmitting apparatus of claim 1, further comprising:
a sensing information generator to generate sensing information using at least one sensor; and
an encryption unit to encrypt the transmission frame,
wherein the transmission frame generator generates the transmission frame using satellite time information, satellite identification information, time difference information, apparatus identification information, the receiving time information, and the sensing information.

7. A position tracking method, comprising:
generating receiving time information based on a time at which Global Positioning System (GPS) information is received; and
generating a transmission frame based on the receiving time information and the GPS information.

8. The position tracking method of claim 7, further comprising:
extracting satellite time information and satellite identification information from the GPS information, and
wherein the generating of the transmission frame comprises generating a transmission frame comprising at least one of the receiving time information, the satellite time information, the satellite identification information, and apparatus identification information.

9. The position tracking method of claim 7, further comprising:
generating time difference information for each satellite, based on the receiving time information and satellite time information,
wherein the generating of the transmission frame comprises generating a transmission frame comprising at least one of the time difference information, satellite time information, satellite identification information, and apparatus identification information.

10. The position tracking method of claim 7, further comprising:
receiving the GPS information from each of a plurality of satellites in an active mode.

11. The position tracking method of claim 7, wherein the generating of the transmission frame comprises discarding the GPS information when the transmission frame is generated.

12. The position tracking method of claim 7, further comprising:
modulating the transmission frame; and
transmitting the modulated transmission frame to a receiving apparatus.

13. A receiving apparatus, comprising:
a frame receiver to demodulate a transmission frame received from a transmitting apparatus; and
a position information generator to generate position information of the transmitting apparatus based on the transmission frame and Global Positioning System (GPS) information.

14. The receiving apparatus of claim 13, wherein the position information generator extracts, from the transmission frame, at least one of receiving time information, time difference information, apparatus identification information, satellite time information, and satellite identification information.

15. The receiving apparatus of claim 14, wherein the position information generator generates the position information of the transmitting apparatus based on the GPS information and the time difference information.

16. The receiving apparatus of claim 14, wherein the position information generator generates time difference information for each satellite, based on the receiving time to information and the satellite time information.

17. The receiving apparatus of claim 13, further comprising:
an interface unit to transmit, to a central server, at least one of the position information of the transmitting apparatus, apparatus identification information, and sensing information; and
a decryption unit to decrypt the transmission frame,
wherein, during the decrypting, the position information generator extracts, from the transmission frame, at least one of receiving time information, time difference information, satellite time information, satellite identification information, the apparatus identification information, and the sensing information.

18. A position tracking method, comprising:
demodulating a transmission frame received from a transmitting apparatus; and
generating position information of the transmitting apparatus based on the transmission frame and Global Positioning System (GPS) information.

19. The position tracking method of claim 18, wherein the generating of the position information comprises:
extracting, from the transmission frame, at least one of receiving time information, time difference information, apparatus identification information, satellite time information, and satellite identification information; and
generating the position information of the transmitting apparatus using the GPS information and the time difference information.

20. The position tracking method of claim 18, further comprising:
transmitting, to a central server, the position information of the transmitting apparatus and apparatus identification information; and
decrypting the transmission frame,
wherein the generating of the position information comprises, during the decrypting, extracting, from the transmission frame, at least one of sensing information, receiving time information, time difference information, satellite time information, satellite identification information, and the apparatus identification information.
